(19) United States
(12) Patent Application Publication
(10) Pub. No.: US 2004/0182644 A1
(43) Pub. Date: Sep. 23, 2004

(54) Rescue harness for injured person and rescuer

(76) Inventor: Todd Kotarski, Addison, IL (US)

Correspondence Address: Adrienne B. Naumann, Esq., 8210 North Tripp, Skokie, IL, 60076, US

(21) Appl. No.: 10/378,545

(22) Filed: Mar. 3, 2003

(51) Int. Cl. A62B 35/00

(52) U.S. Cl. 182/3

(57) ABSTRACT

An improved rescue harness which simultaneously attaches a transporting rescuer to an injured or unconscious person is described herein. The longitudinal shoulder loops, as well as rectangular headrest which supports an injured person's head and neck, allows the rescuer worker to securely and quickly transport a person upon an uneven surface with poor visibility. Other features include the use of flexible materials which are lightweight, and heavy-duty self-locking carabiner clips which attach to the injured person's equipment. My rescue harness also meets OSHA requirements for rescue harnesses generally.

### BACKGROUND OF THE INVENTION

My improved rescue harness for simultaneous use by two persons relates to a device worn by a disabled person who cannot move. More particularly, the preferred embodiment of my improved rescue harness simultaneously attaches to the posterior uniform straps of a disabled emergency professional and the rescuer. The rescuer can slip my improved rescue harness over his shoulders (or retrieve it from a small uniform bag) and attach it to the disabled person. Preferably with the assistance of a second rescuer, the harnessed individual carries the injured colleague to a safe area. My improved rescue harness is a flexible device with shoulder loops for the transporting rescuer, and lower rigid self-locking connectors for the disabled person. The shoulder loops can also be looped around the rescuer's elbows, before the injured person is moved to safety.

There is a long-standing problem for rescue fire workers or police officers, which discover that an injured or unconscious colleague must be moved immediately during an emergency. This is in particularly true for rapid intervention teams, in which an injured colleague together with heavy gear weighs approximately 400 pounds. In addition to quick timing where seconds means lives saved, there is also need to quickly place the injured person onto the harness for head and neck support. Prior art full body harnesses are difficult and time consuming to position, because there is little oxygen, abundant opaque smoke, and no artificial lights in a burning building.

In the past others have devised numerous straps or clothes for supporting a person's weight during quick mobility emergencies. For example, the rescue worker can simply loop a strap around the injured person's waist and shoulders, to slide that person to safety. In other examples, U.S. Pat. No. 6,379,206 (Wallasch) discloses a rescue clamp for victims such as persons within a burning building. This prior art device includes an orifice clamp into which a user's forearm inserts. However, use of this rescue clamp presupposes that fire victim is conscious and capable of intentional physical movement.

Rescue Technology manufactures rescue harnesses for transport of injured persons. However, the Rescue Technology harnesses for the injured person require a full body fitting of that person. As a result, Rescue Technology harnesses are difficult even for a conscious, mentally alert, and uninjured person to slip on rapidly.

Other prior art two-person rescue devices for injured or unconscious uniformed firefighters or police include light duty flexible fabric straps from National Manufacturing Co., Sterling, Ill. These flexible light duty straps are approximately one inch in width and approximately seventy inches in length. This single strap is doubled, looped and cinched under the injured person's armpits, as seen in FIG. 6. The remaining double strap length is wrapped around the rescuer's fist, so that the rescue does not loose his grip while he pulls the injured or unconscious person to safety. These straps are also used for rescuing injured or unconscious civilians. Unfortunately, this method does not protect the head and neck of the injured/unconscious individual. This prior art approach also causes inadvertent sloughing of burned skin from the injured person.

Sling-Link, Inc. of Helotes, Tex., produces a harness-type device for fire/rescue service of a Rapid Invention Team and similar professional fire/rescue groups. This device is carried within a uniform pants pocket or specially designed pouch. However, it does not have the horizontal cervical/head support capability of my improved rescue harness. It is also is not designed for simultaneous attachment to the rescuer and the injured firefighter.

CMS Rescue Equipment of Santa Barbara, Calif. produces harnesses for rescue workers in a sitting position, as well as for fall protection. However, their models do not provide a two-person harness to protect the cervical and head areas of an injured or unconscious person in a prone or an approximately prone position. CMS Rescue Equipment also produces anchor straps, as well as metal carabiners and ladder hooks. None of these devices provide the two-person attachment and neck and head support of my improved rescue harness.

U.S. Pat. No. 6,374,946 (Petzl, et al.) Discloses a roping harness with an offset attachment strip. There are leg loops, and a pair of shoulder straps fixed to the front and rear of the harness, as well as an offset attachment strip formed by an auxiliary extension strap. The person to be rescued uses this device after a fall, because the rope enables the user to self-rescue. This harness is inappropriate for a disabled, physically trapped or unconscious individual.

U.S. Pat. No. 6,256,789(Young et al.) discloses a combination clothing/safety harness for fall arresting and rescue from confined spaces. It attaches to clothing, so that proper placement positions the harness. However, this harness is intended for persons routinely and intentionally working at dangerous heights or within confined spaces. As such, it is inappropriate for disabled or unconscious individuals who must have the harness placed by rescuers within seconds.

U.S. Pat. No. 6,308,355 (Colorado) discloses an extrication harness with a suspender assembly. This extrication harness is adapted for inner liners of a firefighter's turnout suit. The harness strap assembly comprises a single length of webbed strap which winds around the user's buttocks, and through loops suspended at the thigh areas of the inner liners. The intricate pattern of the leg portion of the pants liner makes this particular harness unsuitable for an unconscious or otherwise disabled person. In addition, this harness is designed strictly for one person, and it is not simultaneously worn by an injured/unconscious person.

U.S. Pat. No. 6,367,583(Derby) discloses a capture strap for a rescue harness, as well as its method of use. It includes a strap with a first metal connector which attaches to one end of the strap, and a second metal connector which attaches to the strap's opposite end. This capture strap is looped around the injured person, as well as to the harness of the rescue worker. However this device is designed for use from a helicopter, or by a rescue worker suspended from a safety line.

U.S. Pat. No. 5,787,500(Lobello) discloses a body harness for securing and moving a victim from a dangerous area. It comprises an elongated belt around the victim's chest and under his armpits, and has a release buckle to rapidly fasten the belt ends together around the victim's chest. It also has an elongated hand grasp loop which attaches to the belt around the victim's chest, so the rescue worker locates and grasps the hand grasp loop and drags the injured person to safety. However, this device is not designed to carry a victim to safety but merely to drag the injured person, which is not always an option. In addition, this harness has no provision for the proper cervical and head placement

U. S. Pat. No. 6,379,206(Wallasch) discloses a rescue holding clamp for precariously located victims, such as swimmers in water, climbers in deep ravines, persons atop of a burning building or persons trapped within a well. The person to be rescued inserts a hand and forearm into a spring-loaded clamp. However, this device requires a conscious victim to trigger the clamp's engagement of the hand and forearm, and does not provide proper head and neck placement.

None of the above patent devices are especially adapted for rapid rescue of unconscious and/or physically injured individuals. My device is trust worthier and less likely to injure the victim than a belt, yet it is less cumbersome and time-consuming to apply than a full-body harness.

### SUMMARY OF THE INVENTION

To solve these long-standing problems and needs in the industry, my present rescue harness eliminates a cumbersome full body outfitting for an unconscious or physically disabled rapid intervention rescue professional. The present invention is a harness strap assembly, which simultaneously attaches to an injured firefighter's uniform straps and the rescuer. This improved rescue harness allows the rescuer to quickly attach the harness to the upper body of the transported person, while preventing or minimizing further injury to that person's head and neck. The rescuer can quickly attach the rescue harness to his own shoulders or around his elbow.

The improved body rescue harness comprises flexible fabric materials and at least two lower rigid connecting devices, preferably carabiner clips with keeper pins. Although the flexible fabric straps of longitudinal shoulder loops are preferably sufficiently long to fold along themselves, this is not a necessary feature. The transporting rescuer can easily carry my improved body harness without compromising personal safety: He folds the harness and places within his uniform, attached to a uniform strap or belt, or most preferably upon his own shoulders. However, shoulder placement must be done in a manner which does not compromise the rescuer's own mobility before harness deployment.

In the preferred embodiment and best mode, at the lower portion of the rescue harness rigid connecting devices attached to short flexible loops connect the posterior upper uniform straps of the injured firefighter. In other modes the rescuer loops my improved rescue harness under the armpits of an injured civilian without uniform straps for attachment of rigid metal connectors. The middle portion of the rescue harness comprises a rectangular headrest which supports the injured person's head and neck. In the best mode, a second rescuer without a rescue harness quickly lifts the injured firefighter's legs in an approximately prone horizontal position, and together the two rescuers (one rescuer wearing the harness attached to the injured person) carry the injured person in a horizontal position.

In other embodiments, the rescue harness includes an adjustment device on its upper shoulder loops, so each longitudinal shoulder sloop is quickly shortened. This shortening thus bring the bottommost point of the rigid connecting devices to the appropriate level on the rescuer; i.e., the buttocks and not the knees. These adjustment devices also allow the rescuer to adjust the longitudinal shoulder loops to the head and neck position of the injured person along the middle rectangular headrest. Preferably, each longitudinal shoulder loop adjustable strap ends comprises one rigid circular ring. Each ring can be grasped and pulled downwardly by the rescuer, even if the rescuer wears heavy uniform gloves or mitts.

In the preferred embodiment, carabiner clips with keeper pins attach to flexible fabric straps/loops at the bottom portion of the rescue harness. Short flexible attaching straps/loops can be longer or shorter to accommodate a particular rescuer's height. In other embodiments, the short flexible attaching straps/loops can comprise devices to adjust the length of the loops.

Some prior art rescue harnesses require that the firefighter's legs are first placed into the webbing, and then arms, and finally a strap is placed over the injured person's chest. This procedure takes approximately 1 and ½ minutes to complete, even under ideal conditions. In contrast, my improved rescue harness is placed within seconds, by merely attaching the upper posterior straps of the injured firefighter's uniform to the rescuing firefighters' harness. This quick attachment is an absolute requirement under hazardous conditions and with poor visibility. Most preferably, my harness has two prior art carabiner clips, which are easily opened, but otherwise are automatically self-locking. With this crucial feature, the harness is attached to the injured firefighter within approximately ten to fifteen seconds.

The longitudinal shoulder loops of my harness are adaptable, in a manner similar to a backpack, for a single person drag, and a double firefighter drag. The harness is also designed to protect the injured person's head and neck: cross-straps support the injured firefighter's head, thereby preventing cervical damage.

Accordingly an object of my present new device is to provide a rescue harness which complies with relevant OSHA regulations and guidelines for rescue harnesses.

Another object of my present new device is a rescue harness which is quickly and reliably strapped to an unconscious or physically disabled person, and simultaneously to the rescuer.

Another object of my rescue harness is to provide a series of straps which supports the head and neck of the transported person.

These and other features of my new rescue harness will become apparent after review of the drawings and detailed description of the preferred embodiment and other embodiments, and the best mode of using my invention as well as other modes.

### BRIEF DESCRIPTION OF THE DRAWINGS

FIG. 1: Partial anterior view of the preferred embodiment of my rescue harness.

FIG. 2: Partial posterior view of the preferred embodiment of my rescue harness.

FIG. 3: Lateral close-up view of the preferred embodiment of my rescue harness.

FIG. 4A: Isolated partial anterior view of prior art carabiner clip and close-up view of self-locking mechanism.

FIG. 4B: Close-up view of carabiner clips attaching to posterior uniform straps of injured or unconscious person.

FIG. 4C: Partial anterior view of improved rescue harness in which carabiner clips attach above lower horizontal flexible fabric strap.

FIG. 5A: Partial anterior view of improved rescue harness with adjustable longitudinal shoulder loops.

FIG. 5B: Close-up view of adjustable buckle in FIG. 5A.

FIG. 5C: Close-up view of buckle with strap apertures at predetermined intervals.

FIG. 6: Anterior view of prior art rescue strap worn by an injured individual.

FIG. 7: View of correct position of injured person's head and neck upon preferred embodiment of rescue harness rectangular headrest.

FIG. 8: View of best mode of using rescue harness by attachment to rescuer's shoulders and assistance of a second rescuer.

FIG. 9: View of improved rescue harness when looped around a single rescuer's bent elbow and injured person positioned upon rectangular headrest.

FIG. 10: View of improved rescue harness when attached to injured person, and with longitudinal shoulder loops looped around two rescuers' respective elbows.

FIG. 11: View of rescue harness when looped under an injured civilian's armpits and with rectangular headrest posteriorly positioned along the injured civilian's back.

FIG. 12: Partial posterior view of rescuer wearing preferred embodiment harness with the correct of the rescue harness in the best mode.

### DETAILED DESCRIPTION OF THE PREFERRED EMBODIMENT AND OTHER EMBODIMENTS

Introduction

Rescue harness 100 is particularly designed for, but not limited to, fire rescue work in burning buildings. Using my invention, rapid intervention teams of professional emergency personnel rescue colleagues whenever they may be trapped, unconscious or otherwise disabled, especially in burning buildings.

My rescue harness 100 in the preferred embodiment comprises:

(i) a first and a second longitudinal shoulder loop 101a, 101b respectively as the upper component;

(ii) a rectangular headrest 44 as the contiguous middle portion with intersecting components and;

(iii) two short lower flexible attaching straps 140a, 140b which bear rigid self-locking connectors (preferably carabiner clips 125a, 125b).

As seen in FIG. 12 in the preferred embodiment, first and second longitudinal shoulder loops 101a, 101b are worn by the rescuer in the best mode. There is also a middle rectangular headrest 44 which comprises four sides' 44a, 44b, 110, 120, as well as diagonal intersecting flexible cross-straps 115a, 115b.

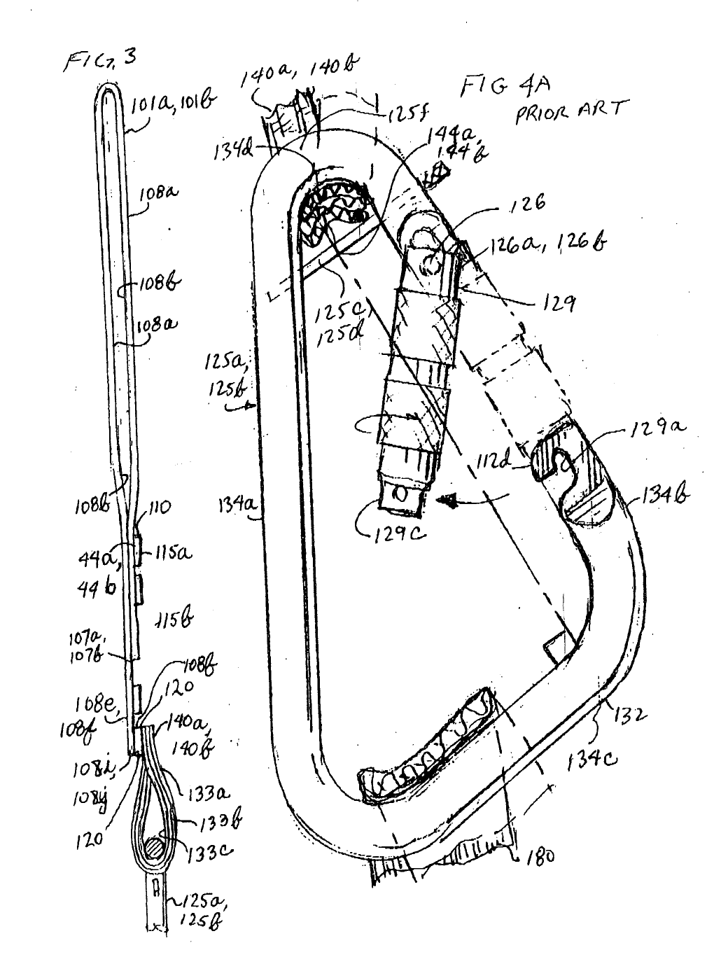

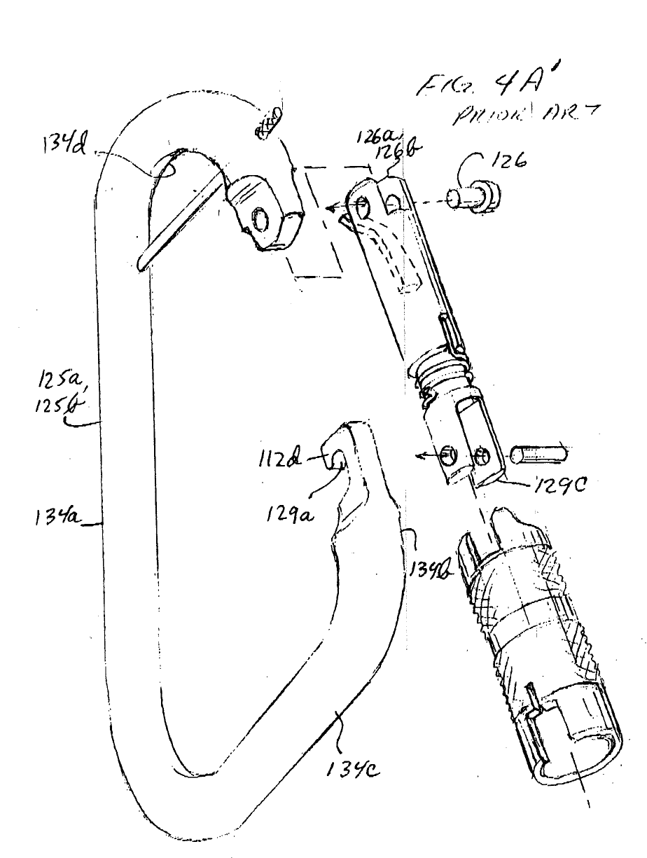

Rescue harness 100 preferably has short flexible attaching loops 140a, 140b with first and second carabiner clips 125a, 125b. When the injured person is another rescue professional, the rigid self-locking connectors attach to the upper ends of that person's posterior uniform straps along his back. Please see FIG. 4B. Carabiner clips 125a, 125b attach the injured firefighter's posterior upper uniform straps to rescue harness 100, while the rescuer wears longitudinal shoulder loops 101a, 101b. However, other rigid self-locking connectors are also within my invention, as long as they comply with the requirements of the federal Occupational Safety and Health Administration [hereinafter ‘OSHA’].

The preferred flexible fabric strap material 121 for my improved rescue harness 100 is available from:

National Manufacturing Co.

Sterling, Ill. 61081

The most preferred flexible nylon strap material 121 from National is:

Durabilt™ 27 inch straps for towing trucks and ratchet tie-downs: Catalogue number: 3307: length 27,″ heavy duty.

Each Durabilt™ 27 inch strap is preferably 2(two) inches in width with the following properties:

(Assembly break strength) A.B.S. 10,000(lbs); 4,538 (kg) and

(working load limit) W.L.L. 3,335(lbs); 1,515(kg.)

In other embodiments, Kevlar® rope is also satisfactory for flexible fabric straps and longitudinal shoulder loops 101a, 101b. Kevlar® rope has the additional advantage of being fire-retardant.

The preferred embodiment of improved rescue harness 100 meets OSHA requirements. Preferred attachment devices are prior art carabiner clips 125a, 125b, each with a positioned keeper pin 125c, 125d. Less preferred are eight-inch carabiner clips 125a, 125b which are otherwise identical in structure and function to six-inch models. Carabiner clips 125a, 125b, or other rigid self-locking connectors must meet OSHA requirements for rescue harnesses

In the preferred embodiment, total harness length is preferably approximately 36 inches from uppermost rescue harness point 103a to bottom rescue harness point 103b. Rescue harness 100 has a width of approximately 13.5 inches from first exterior harness side strap edge 44aa to second exterior rescue harness side strap edge 44bb(whenever rescue harness 100 extends to its full width and length).

The rescuer stores rescue harness 100 within his uniform, in a belt, or upon his or her shoulders, so rescue harness 100 is always available. When an emergency occurs, longitudinal shoulder loops 101a, 101a are already along the rescuer's shoulders, thereby eliminating struggle with a complex strap arrangement.

Longitudinal Shoulder Loops 101a, 101b

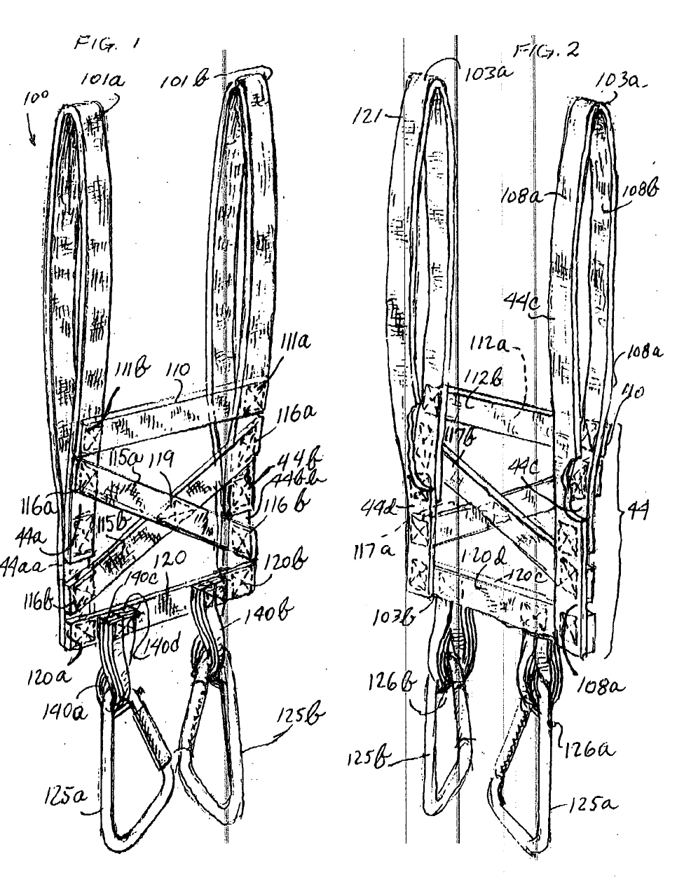

Referring now to FIGS. 1,2 and 3, at topmost rescue harness points 103a, 103aa are first and second longitudinal shoulder loops 101a, 101b respectively. Longitudinal shoulder loops 101a, 101b preferably slip over the shoulders of the rescue worker, either for storage or use. Please see FIG. 12. Each longitudinal shoulder loop 101a, 101b is made of Durabilt™ flexible nylon washable fabric, with the strength characteristics described, supra. Each longitudinal shoulder loop 101a, 101b is preferably approximately:

(i) 21 inches in length;

(ii) (ii) approximately 53.5 inches in total length from each corresponding overlapped first loop shoulder strap end 107a, to second loop shoulder strap end 108i, 108j respectively;

(iii) approximately 2.0 inches in width; and

(iv) approximately 1/16 inch in thickness.

As seen in FIG. 3, in the preferred embodiment, each first and second flexible longitudinal shoulder loops 101a, 101b overlaps upon itself, thus forming a double thickness of flexible strap material along each vertical opposing parallel strap side 44a, 44b. However, my invention includes other embodiments in which longitudinal shoulder loops 101a, 101b, are physically discontiguous from straps comprising rectangular headrest 44. My invention also includes embodiments in which each longitudinal shoulder loop 101a, 101b is discontinuous, so that each longitudinal shoulder loop 101a, 101b is adjustable by pulling upon a single strap, infra.

As best seen in FIG. 2 each longitudinal shoulder loop 101a, 101b has an anterior loop surface 108a and a posterior loop surface 108b. Preferably each longitudinal shoulder loop 101a, 101b becomes contiguous corresponding flexible straps 44c, 44d which also form parallel opposing sides 44a, 44b. As seen in FIG. 3, each posterior surface 108b folds onto and attaches to itself, thereby creating a single first and second corresponding posterior lower contiguous segment 108e, 108f respectively. Each lower contiguous segment 108e, 108f has a corresponding segment end 108i, 108j respectively. In this manner, each loop shoulder strap end 107a, 107b attaches to the corresponding middle posterior loop surface 108b. In the preferred embodiment, each longitudinal shoulder loop 101a, 101b is identical in function, dimensions and structure to the other.

The length of each rectangular strap side 44a, 44b is approximately 15 inches while the length of each non-overlapped contiguous lower strap segments 108e, 108f are each approximately 5.5 inches. Each loop shoulder strap end 107a, 107b preferably attaches to corresponding middle posterior surface 108b by machine stitching with thread. A rescue harness 100 made in this matter will not disattach under a 3,335 pound working load.

Non-integral longitudinal shoulder loops 101a, 101b that attach to middle rectangular headrest 44 are also within the scope of my invention. However, the physical attachment of shoulder loop 101a, 101b to middle rectangular portion 44 must be (i) sufficiently strong to withstand the full weight of a large adult plus his equipment and; (ii) otherwise fulfill OSHA requirements.

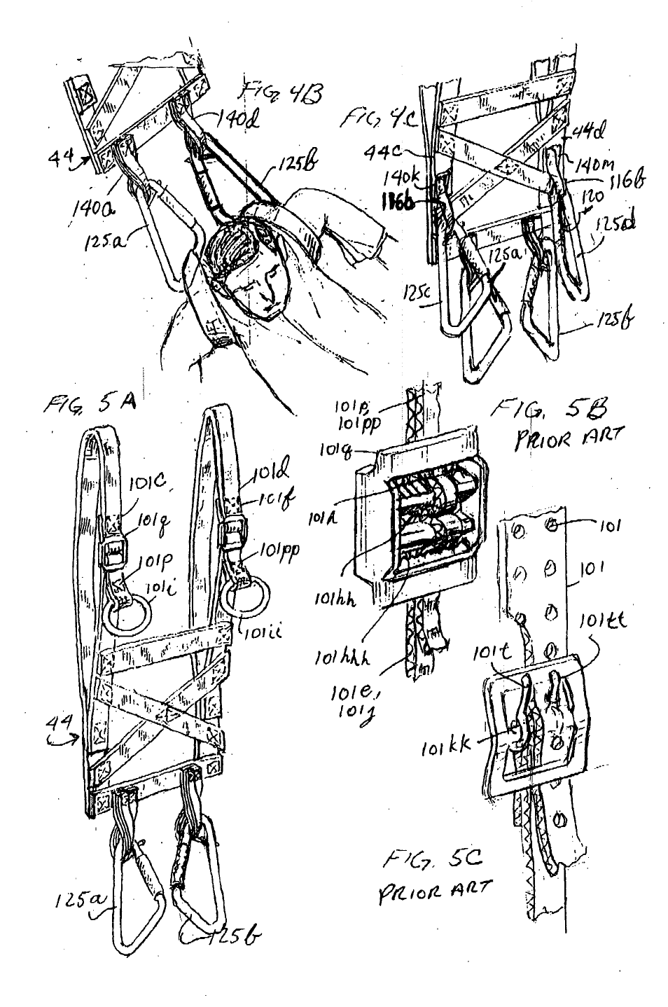

Referring now to FIGS. 5A, 5B in another embodiment each adjustable longitudinal shoulder loop 101c, 101d consists of two physically separate flexible straps: short attaching strap 101p, 101s and longer attaching straps 101e, 101f. Each short attaching strap 101p, 101s connects to buckle 101g, while longer attaching straps 101e, 101f slide through buckle 101g. Buckle 101g has an upper opening 101h for attachment of shorter attaching straps 101p, 101s, while longer attaching strap 101f slides through opposing adjacent lower buckle openings 101hh, 101hhh.

First and second buckle bars 101j, 101jj each comprises upper rows of small teeth 102a. Teeth 102a frictionally and mechanically retain shorter attaching straps 101p, 1011s and longer attaching straps 101e, 101f, within their respective buckle openings.

To shorten longer attaching straps 101e or 101f, the rescuer pulls downwardly upon both metal circular rings 101i or 101ii at the end of each corresponding longer attaching strap 101e, 101f respectively. To lengthen longer attaching strap 101e or 101f, rescuer firefighter pulls longer attaching strap 101e, 101f upwards through lower buckle opening 101hhh. He then pulls downwardly on each longer attaching strap 101e, 101f. This last step equalizes the doubled length of the longer attaching strap 101e, 101f, thereby shortening the effective vertical length of adjustable longitudinal shoulder loops 101c, 101d.

To pull effectively on each longer attaching strap 101e, 101f respectively requires first and second rigid metal circular rings 101i, 101ii respectively. Circular rings 101i, 101ii at the end of each longer corresponding longer attaching strap 101e, 101f are at least approximately four inches in diameter. This diameter and shape of circular grasps 101i, 101ii allows quick adjustment even when the rescuer wears heavy mitts which limit dexterity. Other shapes of rings 101i, 101ii are also within the scope of my invention, as well as other large objects to grasp. Other adjusting devices are also within the scope of my invention. However, this embodiment with discontinuous adjustable straps is recommended whenever the rectangular headrest 44 must be adjusted to align at the correct vertical height along the rescuer's back.

Referring now to FIG. 5C, in other embodiments, buckle 101g congruently with predetermined paired apertures 101u, 101uu. Buckle 101g has no teeth 102aa, but instead comprises two prongs 101t, 101tt attaching to a middle buckle bar 101kk. This embodiment is recommended for firefighter/rescuers who adjust the length the rescue harness 100 prior to entering the emergency area, and prior to wearing thick uniform gloves or mitts.

Rectangular Headrest 44

Referring again to FIGS. 1 and 2 of the preferred embodiment, rectangular headrest 44 is rectangular or square in length and width. However, other shapes of rectangular headrest 44 are also within the scope of my invention. Upper horizontal flexible fabric strap 110 is the uppermost component of rectangular headrest 44. Upper horizontal flexible fabric strap 110 preferably comprises the same flexible fabric 121 as first and second longitudinal shoulder loops 101a, 101b. First horizontal flexible fabric strap 110 is preferably approximately 2.0 inches in width, 1/16 inch in thickness, and 15.5 inches in length.

Still referring to FIGS. 1 and 2, each rectangular headrest portion 44 has two opposing side straps 44a, 44b. Each opposing side strap 44a, 44b preferably is contiguous with corresponding flexible straps 44c or 44d respectively which comprise corresponding longitudinal shoulder loops 101a, 101b. Other dimensions are also within my invention, but preferably horizontal flexible fabric strip 110 has the same thickness and width as longitudinal shoulder loops 101a, 101b. Flexible fabric 121 comprising upper horizontal flexible fabric strap 110 is sufficiently strong to support an adult carrying heavy equipment.

Still referring to FIG. 1, upper horizontal flexible fabric strap 110 has a first flexible upper horizontal end 111a and a second upper flexible horizontal end 111b. Upper horizontal flexible fabric strap 110 also has an anterior upper horizontal fabric surface 112a and a posterior upper horizontal fabric surface 112b. Each first and second upper flexible horizontal end 111a, 111b attaches to its corresponding longitudinal shoulder loop anterior surface 108a. In some embodiments, upper horizontal flexible fabric strap 10 is an integral and contiguous component of longitudinal shoulder loops 101a, 101b . In other embodiments horizontal flexible fabric strap 110 attaches along posterior longitudinal shoulder loop surface 108b, instead of anterior surface 108a, by thread stitching or other devices.

Referring to FIGS. 1, 2 and 3, located immediately below upper horizontal flexible strap 110 are first and second diagonal flexible cross-straps 115a, 115b respectively. Each first and second diagonal flexible cross-strap 115a, 115b is preferably approximately:

(i) 17 inches in length,

(ii) 2.0 inches in width; and

(iii) Approximately 1/16 inch in thickness.

Each diagonal flexible cross-strap 115a, 115b has an upper diagonal cross-strap end 116a and lower diagonal cross-strap end 116b. Each diagonal flexible cross-strap 115a, 115b also has an anterior diagonal cross-strap surface 117a and a posterior diagonal cross-strap surface 117b. Each upper diagonal cross-strap end 116a attaches to longitudinal loop shoulder anterior surface 108a by posterior diagonal cross-strap surface 117b(FIG. 3).

Similarly, each lower diagonal cross-strap end 116b preferably attaches to longitudinal shoulder loop anterior surface 108a at posterior diagonal cross-strap surface 117b. First and second diagonal cross-straps 115a, 115b intersect each other to create an “x” 119 at approximately the midpoint of rectangular headrest 44. Each upper diagonal cross-strap upper end 116a attaches immediately below and adjacent to first and second ends 111a, 111b of upper horizontal flexible fabric strip 110.

In other embodiments, each diagonal cross-strap 115a, 115b comprises an integral contiguous component of each longitudinal shoulder loop 101a, 101b. In addition, each diagonal cross-strap 115a, 115b attaches to posterior surface 108b of each corresponding longitudinal shoulder loop 101a, 101b, instead of anterior surface 108a. In still other embodiments, there are more than two diagonal cross-straps 115a, 115b.

Each diagonal cross-strap 115a, 115b is preferably made of the same flexible nylon material 121 as longitudinal shoulder loops 101a, 101b and upper horizontal flexible fabric strip 110. First and second diagonal cross-strap 115a, 115b are stitched together at their intersection. Stitching 123 is preferably in a manner similar to upper horizontal flexible fabric strip 110, and loop shoulder straps 101a, 101b: i.e., the stitching forms a parallelogram or square with an “x” interiorly. However, other means of attachment with sufficient strength for OSHA requirements are also within the scope of my invention.

Still referring to FIGS. 1 and 2, in the preferred embodiment rectangular headrest 44 also comprises lower horizontal flexible fabric strap 120. Lower flexible fabric strap 120 lays immediately below first and second diagonal cross-straps 115a, 115b. Lower horizontal flexible fabric strap 120 has a first lower flexible end 120a and a second lower flexible end 120b. Lower horizontal flexible fabric strap 120 also comprises an anterior lower horizontal surface 120c and a posterior lower horizontal surface 120d. Each lower flexible end 120a, 120b preferably attaches to corresponding anterior longitudinal shoulder loop surface 108b at single first and second lower flexible ends 108i, 108j. (FIG. 3).

Rectangular headrest side's 44a, 44b oppose and are parallel to each other in the preferred embodiment. Lower and upper flexible horizontal straps 110, 120 respectively oppose and are parallel to each other. Horizontal flexible upper and lower straps 110, 120 respectively attach to rectangular headrest sides 44a, 44b at right angles in the preferred embodiment, thereby forming a rectangular or less preferably a square. Lower horizontal flexible fabric strap 120 preferably has the same width, length, and thickness as upper horizontal flexible fabric strap 110.

Strap 120 is also preferably made of flexible fabric 121, described supra, for longitudinal shoulder loops 101a, 101b, upper horizontal flexible fabric strap 110, and flexible diagonal cross-straps 115a, 115b. Lower horizontal flexible fabric strap 120 is designed to support the injured person's neck at the fifth cervical (C5) vertebra.

Each lower first and second flexible end 120a, 120b respectively preferably attaches to posterior surface 108a, with nylon thread stitching as described for longitudinal shoulder loops 101a, 101b, upper horizontal flexible strap 110, and flexible diagonal cross-straps 115a, 115b. However, other attaching devices are also satisfactory, as long as they meet OSHA requirements. Stitching is preferably a square or parallelogram outline with an “x” interiorly, but other patterns and thread are satisfactory if they fulfill OSHA strength requirements

Lower Attaching Devices

Small Flexible Loop Attachments 140

Referring now to FIGS. 1, 2 and 4A of the preferred embodiment, along lower horizontal anterior strap surface 120c first and second small flexible small loop devices 140a and 140b respectively. Small flexible small loop devices 140a, 140b are equidistantly spaced from first and second lower opposite ends 120a, 120b respectively

by approximately two inches. Each small flexible loop attachment 140a or 140b is preferably approximately 13 inches in length when fully extended and not attached to lower horizontal flexible strap 120. Each first and second small flexible loop device 140a, 140b has a first small loop end 140c and a second small loop end 140d.

Each small loop end 140c, 140d is preferably firmly machine stitched adjacent to the other along anterior lower horizontal flexible fabric strip surface 120c. This stitching is preferably accomplished with the nylon thread, method and design described supra for longitudinal shoulder loops 101a, 101b, rectangular headrest 44, cross-straps 115a, 115b, and horizontal flexible fabric straps 110, 120. However, other kinds of stitching, as well as other attachment devices are also satisfactory, as long as they fulfill OSHA requirements.

Each small flexible loop attachment 140a, 140b is preferably approximately five inches in length when doubled and attached to lower horizontal flexible strap 120. Each attachment 140a, 140b is also approximately 1.5 inch in width and ¼ inch in thickness. All fabric layers 133 are preferably stitched to anterior lower horizontal surface 120c with a parallelogram or square design with an “x” interiorly. Preferably there are three flexible fabric layers 133a, 133b, 133c (generically 133) of flexible fabric 121 comprising each loop attachment 140a, 140b , and each layer 133 is approximately 1/16 inch in thickness. However, less or more than three layers 133 are also within the scope of my invention. Each small flexible attachment loop 140a, 140b length can vary and remain within my invention.

Each pair of small loop ends 140c, 140d for each corresponding small flexible loop attachment 140a; 140b is preferably spaced from the other approximately five inches along lower horizontal flexible strap 120. There are preferably two small flexible loop attachments 140a, 140b connected to lower horizontal flexible strap 120, but one or more than two small flexible loop attachments 140a, 140b are also within my invention.

Rigid Self-Locking Connectors

Still referring to FIGS. 1 and 2 of the preferred embodiment, suspended from each small flexible loop attachment 140a, 140b is a first prior art carabiner clip 125a, and a second prior art carabiner clip 125b respectively. Each prior art carabiner clip 125a, 125b is preferably made of steel and is approximately six to eight inches in longitudinal length. However, other lengths of carabineer clips 125a, 125b are also acceptable and other satisfactory metals include aluminum. Satisfactory carabiner clips 125a, 125b are available from

CMC Rescue, Inc.

P.O. Drawer 6870

Santa Barbara, Calif. 93160

Model No.370090, 370093

Phone number: 805: 562-9120

Other connecting devices are also within my invention, as long as they meet OSHA strength and self-locking requirements. Preferred carabiner clips 125a, 125b easily open, but self-lock and remain closed under force from all angles. This self-locking feature 129 supports an adult's full body weight plus equipment.

Referring now to FIG. 4A, each prior art carabiner clip 125a, 125b has an approximately triangular shape which is preferably approximately six to eight inches in length from apex 125f to base 134c along longitudinal perpendicular line 45. Steel frame 132 of carabiner clip 125a, 125b has a diameter of approximately 0.5 inch. Carabiner clips 125a, 125b are preferably identical to the other along each lower horizontal flexible fabric strip 120. Each carabiner clip 125a, 125b is oriented so each self-locking mechanism 129 is located along the shorter central interior side of 134b each corresponding carabiner clip 125a, 125b. FIG. 4A.

Each carabiner clip 125a, 125b also includes a corresponding first and second keeper pin 125c, 125d respectively. Each keeper pin 125c, 125d inserts within both narrower converging sides 134a, 134b (which form triangular apex 125f). Carabiner openings 144a, 144b are created within each carabiner clip 125a, 125b by corresponding keeper pin 125c, 125d and two converging sides 134a, 134b. Each flexible fabric loop 140a, 140b passes through each respective carabiner opening 144a, 144b, thereby flexibly attaching each carabineer clip 125a, 125b to lower horizontal flexible fabric strip 120.

Self-locking mechanism 129 comprises an first upper spring pin, or pivot pin 126, with a tight friction fit. Referring to FIGS. 4A and 4A′, to open carabiner clip 125a, 125b, spring biased self-locking mechanism 129 is first manually rotated counterclockwise. Clip side 134b, while simultaneously pushing mechanism 129 toward carabiner side 134a.

First spring 128a rotates and flexes when the rescuer grasps mechanism 129 and rotates mechanisms 129t counterclockwise. Second longitudinal spring 128a flexes when pushed towards carabiner side 134a, and spring 128a immediately returns to its non-flexed position (i.e., to a closed locked position) whenever mechanism 129 is manually released. Lower prong 129e upon carabiner side end 134bb fits snugly into lower mechanism notch 129f, whenever mechanism 129 snaps backs into the default locked position, after the rescuer manually releases second longitudinal spring 128b.

Referring now to FIG. 4C, in other embodiments each third and fourth carabiner clip 125c, 125d is positioned higher vertically along each flexible strap side 44a, 44b. Each carabiner clip 125a, 125b is positioned along lower strap end 116b. Each carabiner clip 125a, 125b attaches at this vertically higher position by corresponding upper flexible loops 140k, 140m. In this embodiment each carabiner clip 125c, 125d is approximately three inches above the bottom edge of lower horizontal flexible fabric strip 120.

In a variation of this embodiment, smaller horizontal flexible loops 136a, 136b provide additional attachments along strap sides 44c, 44d. Also in this variation, original flexible fabric loops 140a, 140b remain along lower horizontal flexible fabric strip 120, in the event that carabiner clips 125a, 125b are attached to lower horizontal flexible fabric strap 120. Please see FIG. 4C.

Modes of Using Rescue Harness 100

As seen in FIG. 12, my rescue harness's longitudinal shoulder loops 101a, 101b extend anteriorly along sides of the rescuer's abdomen and chest, and posteriorly along the rescuer's back. When not in use, rescue harness 100 is folded into a small bag upon the rescuer's belt and/or uniform, or simply attached to the rescuer's uniform at the shoulder area.

Best Mode

As seen in FIG. 7, the rescuer initially positions the injured person's neck at the fifth cervical vertebrae (C5) along lower horizontal flexible fabric strap 120. He or she also carefully positions the injured person's head upon flexible intersecting cross-straps 115a, 115b. Each firefighter carries a small oxygen tank upon his back, and this tank are attached to the firefighter by a strap network which functions similarly to a backpack. There is also a lower harness element, which balances the tank and encircles the firefighter's waist, with the shoulder straps also attached thereto. Please see FIG. 4B. The rescuer attaches carabiner clips 125a, 125b to the exposed upper narrow straps at the posterior of the injured firefighter's oxygen tank straps. He then makes the appropriate length adjustment to longitudinal shoulder loops, if the harness is adjustable.

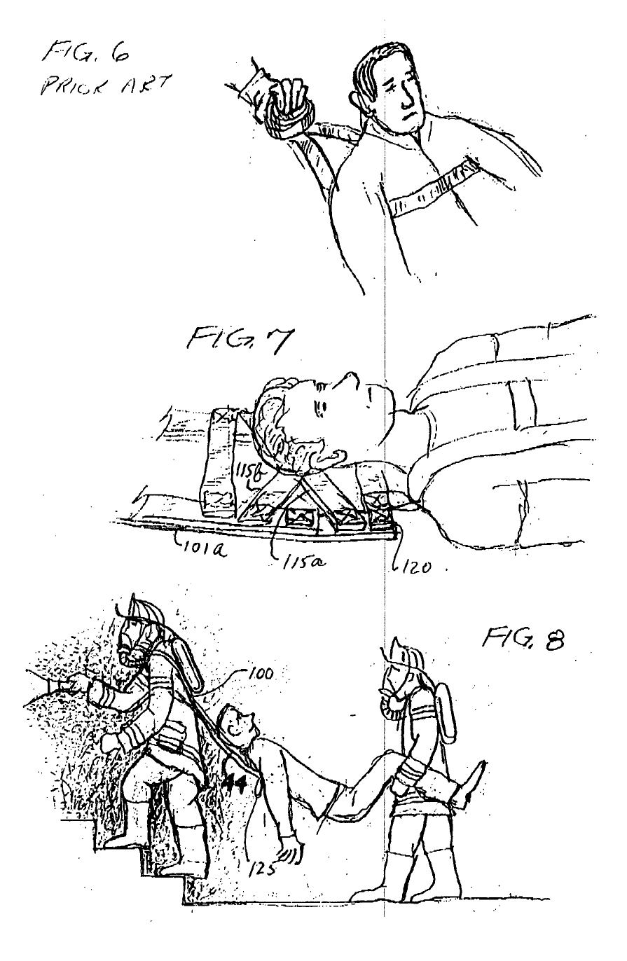

Referring now to FIG. 8, the rescuer quickly places a longitudinal shoulder loop 101a, 101b over each of his own shoulders. As seen in FIG. 12, carabiner clips 125a, 125b are no lower than the rescuer's buttocks, for proper position of the injured person's head and neck. The rescuer confirms that the injured person's head and shoulders remain properly positioned as described supra. Preferably a second non-harnessed rescuer lifts the injured persons legs and moves with the harnessed rescuer. This best mode approach is ideal for transporting the injured person up a flight of stairs or other non-level surface with poor visibility.

Other Modes

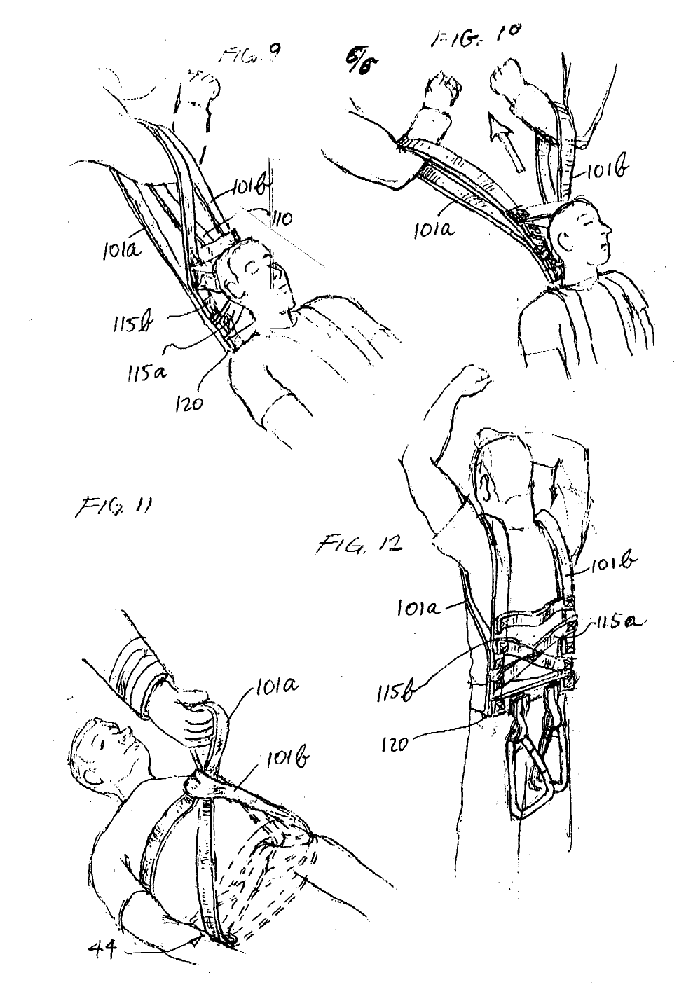

Referring now to FIG. 10, in another mode of using of rescue harness 100, two transporting rescue workers each slip one arm inside one shoulder loop 101a, 101b and slide the injured person along a level surface. As seen in FIG. 9, in a third mode the transporting rescuer slides both shoulder loops 101a, 101b over one bent arm, and slides the injured person along a level surface. In both these modes, the rescuer confirms that the transported person's head and neck are supported by rectangular headrest 44. In particular, the rescuer must check for proper placement of the fifth cervical vertebra in the center of lower horizontal flexible fabric strap 120.

FIG. 11 illustrates use of rescue harness 100 for a civilian without posterior uniform straps. The rescuer loops the longitudinal shoulder straps 101a, 101b under the injured person's armpits, and confirms that rectangular headrest 44 is along the injured person's back. Harness 100 is cinched anteriorly under the injured person's armpits. The rescuer then wraps longitudinal shoulder loops 101a, 101b several times around his elbow and fist and pulls the person to safety.

### CONCLUSIONS

The above text is a description of the best mode and preferred embodiment of my improved rescue harness. However, those skilled in this art may see variations within my rescue harness's scope by changing the dimensions and shapes of its various components. For example, they could make the harness of various fabrics.

Accordingly, since my rescue harness can be embodied in specific forms without departing from the spirit or essential characteristics thereof, the present preferred embodiment is therefore considered illustrative and not restrictive. The scope of my rescue harness invention is indicated by the appended claims, and all changes which come within the meaning and range of equivalency of the claims are embraced therein.

1. An improved rescue harness, said improved rescue harness having a highest point a lowest point, a length and a width, said rescue harness comprising:
(A) At least two longitudinal shoulder loops, each said shoulder loop attached to a first physically able transporting rescuer,
(B) A rectangular headrest, said rectangular headrest comprising a network of flexible straps, said rectangular headrest attached to said longitudinal shoulder loops, said rectangular headrest positioned lower along said rescue harness, and
(C) A lower harness portion, said lower harness portion comprising at least two flexible fabric strips with rigid attaching devices, said rigid attaching devices connecting a second person to said rectangular headrest,
Whereby said rescue harness simultaneously attaches to a transporting person by said shoulder loops and to a transported person by said rigid attaching devices, said headrest supporting the head and neck of said second person.

2. The rescue harness described in claim 1 wherein each said rigid attaching device is a carabiner clip and said rectangular headrest is rectangular with two intersecting interiorly positioned straps.

3. The rescue harness as described in claim 1 wherein each said rigid attaching device attaches along each opposing vertical rectangular side of said rectangular headrest.

4. The rescue harness described in claim 2 wherein each said flexible strap comprises a flexible nylon fabric.

5. The rescue harness as described in claim 5 wherein each said first carabiner clip and said second carabiner clip attaches to said rectangular headrest by a first flexible fabric loop and a second flexible fabric loop respectively.

6. A rescue harness, said rescue harness comprising
(A) A shoulder component, said shoulder component comprising
(1) a first longitudinal shoulder loop of flexible material, and a second longitudinal shoulder loop of flexible material, said elongated shoulder loops contiguous with the remaining components of said rescue harness, each said longitudinal shoulder loop further comprising a first loop adjusting device and a second loop adjusting device respectively,
(B) a head and neck support, said head and neck support being physically contiguous with said shoulder component, said head and neck support comprising
(1) A diagonally crossing first strap and a diagonally crossing second strap, each said diagonally crossing strap comprising a length, an anterior and a posterior surface, and an upper end and a lower end,
(2) said diagonal cross-straps attaching at their upper and lower ends to a first parallel opposing vertical strap and a second parallel opposing vertical strap, said two parallel opposing vertical straps doubled in thickness at the middle third of their respective lengths, said parallel opposing vertical straps also comprising said longitudinal shoulder loops,
(3) An uppermost horizontal flexible strap and a lowest horizontal flexible strap, said flexible straps being parallel to each other, said flexible straps each having a first end and a second end, said flexible straps attached to said parallel opposing straps by their respective first and second ends,
Said parallel vertical opposing straps and said uppermost and lowest horizontal flexible straps thereby forming a quadrilateral polygon, said quadralateral polygon further comprising first and second diagonally oriented cross-strap, said diagonally oriented cross-straps comprising a support for a person's neck and head,
(C) a lower attaching component, said lower attaching component comprising spring biased rigid self-locking connector, said spring biased rigid self-locking connectors attached to said lower horizontal flexible strap by two flexible fabric loops, said spring biased rigid self-locking connectors,
Whereby said longitudinal shoulder loops attach to a transporting person, while said rectangular shape supports a transported person's head and neck, said transported person attached to said rescue harness by said spring biased rigid self locking connectors.

7. The rescue harness as described in claim 5 wherein said shoulder harness is made of a flexible nylon material which is approximately ¼ inch in thickness, and said first and second longitudinal shoulder loop is approximately 21 inches in length.

8. The rescue harness as described in claim 6 wherein said rigid spring biased self-locking connectors are carabiner clips.

9. The rescue harness as described in claim 7 wherein said length of each longitudinal shoulder loop is manually adjustable by adjustment devices.

10. The rescue harness as described in claim 8 wherein said adjustment device comprises a buckle.

11. The method of using the rescue harness as described in claim 7 wherein said transporting person slips each longitudinal shoulder loop over each of his shoulders after attaching a transported person to said rigid self-locking rigid connectors, said transporting person adjusting said head and neck of said transported person upon said rectangular portion, said rescuer thereafter transporting said transported person upon a non-horizontal or uneven surface with poor visibility.

12. A method for rescuing a person comprising the steps of:
(A) Providing a rescue harness, said rescue harness comprising
(1) two adjustable longitudinal shoulder loops, each said longitudinal shoulder loop comprising an anterior surface and a posterior surface, each said longitudinal shoulder loop comprising a first end and a second end, each said longitudinal shoulder loop comprising an bottom point and an upper point, each said longitudinal shoulder loop comprising a single flexible strap at said bottom point,
each longitudinal shoulder loop comprising a connecting device for adjusting the length of said longitudinal shoulder loop,
said longitudinal shoulder loops each further comprising parallel opposing flexible straps of a attached rectangular headrest, said rescue harness further comprising two opposing parallel flexible horizontal straps, said two opposing parallel horizontal straps forming the two remaining sides of said rectangular headrest, said two opposing parallel horizontal straps forming right angles when attached to said parallel opposing vertical flexible straps,
said rectangular portion further comprising a first diagonal cross-strap and a second cross-strap, said diagonal cross-straps intersecting at approximately the midpoint of said rectangular portion, each diagonal strap having a third end and a fourth end, each said third and fourth end attached to said parallel opposing flexible straps comprising said longitudinal shoulder loops,
Said rectangular portion further comprising a first short flexible connecting strap and a short second flexible connecting strap, each short flexible connecting strap attaching to said lower opposing parallel horizontal flexible strap, each short flexible connecting strap further comprising a rigid spring biased self-locking connector,
(B) Providing a first and second rescuer for transporting an unconscious or injured person,
(C) Providing an injured, trapped or unconscious person to rescue by manual transport, said person positioned along a surface in a prone position,
(D) Placing said rescue harness upon said first rescuer so that each said longitudinal shoulder loop encircles a respective shoulder of said first rescuer, and said rectangular portion drapes over said first rescuer's back,
(E) Positioning said first rescuer at the head of said injured or unconscious person, so that said metal connectors are attached to said injured or unconscious person's posterior uniform straps by said second rescuer, said second rescuer positioning said injured person's head upon said rectangular portion,
(F) Positioning said second rescuer so that he lifts said injured person's legs simultaneously with said first rescuer's rise from a kneeling position.
